(19) United States
(12) Patent Application Publication
(10) Pub. No.: US 2005/0134733 A1
(43) Pub. Date: Jun. 23, 2005

(54) Caption data, and digital television receiver using caption data and caption data displaying method

(76) Inventor: Jeong Hye Yang, Jeju-si (KR)

Correspondence Address: MCKENNA LONG & ALDRIDGE LLP;Song K. Jung, 1900 K Street, N.W., Washington, DC, 20006, US

(21) Appl. No.: 11/013,455

(22) Filed: Dec. 17, 2004

(30) Foreign Application Priority Data
Dec. 20, 2003 (KR) 10-2003-0094199

(51) Int. Cl. H04N 7/00

(52) U.S. Cl. 348/468

(57) ABSTRACT

A digital television receiver using caption data is disclosed. The receiver including: a tuning unit for receiving a predetermined channel broadcasting signal through an antenna; a demodulator for demodulating the received broadcasting signal; a demultiplexer for separating an audio signal and a video signal from an output signal of the demodulator; a video decoder for decoding the separated video signal to separate the caption data from the decoded video signal; a video processing unit for processing the decoded video signal; a caption decoder for decoding the separated caption data to read time information for a caption data display; and a controlling unit for controlling to display the caption data at a corresponding time by using the decoded caption data and the time information.

This application claims the benefit of the Korean Application No. 10-2003-0094199 filed on Dec. 20, 2003 which is hereby incorporated by reference.

### BACKGROUND OF THE INVENTION

1. Field of the Invention

The present invention relates to a broadcasting program, and more particularly, to a caption data displaying method in which a broadcasting station inserts caption data into a digital broadcasting program to transmit the inserted caption data, and a digital television receiver receives the transmitted caption data to display the received caption data on a screen.

2. Discussion of the Related Art

Due to the introduction of a digital television receiver, caption data is transmitted in a digital signal, not in an analogous signal. The digital television receiver receives a broadcasting program and extracts the caption data from the received broadcasting program, and decodes the extracted caption data in a caption decoder to display the decoded caption data on a screen by using an On. Screen Display (OSD) and the like.

However, in ATSC (Advanced Television System Committee) EIA708-B widely used in U.S.A., South Korea and the like, when the caption data is inserted into a video program and transmitted, that is, when the caption data is inserted into the user data area of a video picture layer and transmitted, the caption data is loaded in the user data area of the video picture layer and transmitted. Therefore, the time information does not need to be intentionally separately transmitted.

FIG. 1 is a view illustrating a structure of a conventional caption data transmitted. According to the EIA708-B, the time information at which the caption data is displayed on the screen is not loaded within the caption data and transmitted.

In case where the caption data is loaded in the received video program, the digital television receiver separates the caption data, and decodes the separated caption data in a caption decoder to display the caption data on the screen. At this time, a time point at which the caption data is displayed on the screen is not separately provided, and the caption decoder immediately decodes the received caption data to display the decoded caption data on the screen.

As such, in case where the caption data is loaded in the video data, the video data is decoded and at the same time, the caption data is decoded while being displayed on the screen. At this time, the time point at which the caption data is displayed on the screen is not separately determined, the caption data is received and at once, the video data is decoded while the caption data is almost concurrently decoded and displayed on the screen. Therefore, it is difficult to display the caption data at an exact time required by the broadcasting station.

Of course, it is not a big matter that the caption data is displayed a little earlier or a little later, but the digital television receiver cannot display the received caption data on the screen at the exact time required by the broadcasting station. Accordingly, it is difficult to display the caption data at the exact time required by the broadcasting station.

Further, when the caption data is inserted into the video program and the video program is transmitted with the caption data at the broadcasting station, it is difficult to satisfy the case where it is required to display the caption data a few seconds later even though the caption data is currently transmitted, or where the caption data is inserted into the video program and transmitted, due to too large caption data, in advance before it is required to display the caption data on the screen.

Additionally, in case where the caption data is a little delayed and displayed, or in case where it is determined that the caption data is much delayed by comparing the time information with the system current time, a corresponding caption data is not displayed and a next caption data can be displayed.

However, since the transmitted caption data should be continuously displayed in a caption data configuration, the caption data cannot be appropriately processed a long time later. Accordingly, the conventional digital television receiver has a drawback in that the caption data cannot be displayed as intended by the broadcasting station.

### SUMMARY OF THE INVENTION

Accordingly, the present invention is directed to caption data, and a digital television receiver using the caption data and a caption data displaying method that substantially obviate one or more problems due to limitations and disadvantages of the related art.

An object of the present invention is to provide a caption data displaying method in which time information, at which caption data is displayed on a screen, is inserted into the caption data to allow a digital television receiver to display the caption data at an exact time required by a broadcasting station.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided caption data having time information for a caption data display in an MPEG, (Motion Picture Experts Group) user data area.

Preferably, the caption data is used in an ATSC (Advanced Television System Committee) broadcasting signal.

Preferably, the time information is comprised of caption presentation time data and reserved data, and the caption presentation time data is 33 bits, and the reserved data is 7 bits.

In another aspect of the present invention there is provided a digital television receiver using caption data, the receiver including: a tuning unit for receiving a predetermined channel broadcasting signal through an antenna; a demodulator for demodulating the received broadcasting signal; a demultiplexer for separating an audio signal and a video signal from an output signal of the demodulator; a video decoder for decoding the separated video signal to separate the caption data from the decoded video signal; a video processing unit for processing the decoded video signal; a caption decoder for decoding the separated caption data to read time information for a caption data display; and a controlling unit for controlling to display the caption data at a corresponding time by using the decoded caption data and the time information.

Preferably, the receiver further includes: an OSD (On Screen Display) unit for generating an OSD signal of the caption data at a corresponding time under the control of the controlling unit by using the read time information, to synthesize the generated OSD signal with the processed video signal.

Preferably, the receiver further includes: an audio processing unit for decoding and processing the audio signal outputted from the demultiplexer so that a user can listen to the audio signal.

Preferably, the receiver farther includes: a memory for temporarily storing the decoded caption data and the time information.

Preferably, the receiver further includes: an OSD (On Screen Display) unit for generating an OSD signal of the caption data at a corresponding time under the control of the controlling unit by using the stored time information, to synthesize the generated OSD signal with the processed video signal.

Preferably, the video decoder decodes the separated video signal to read the caption data.

Preferably, the caption decoder decodes the separated caption data to transmit the existence or absence of the time information to the controlling unit.

Preferably, the controlling unit controls to immediately display a corresponding caption data or display the caption data at a corresponding time, depending on the transmitted existence or absence of the time information.

Preferably, the controlling unit includes: a comparator for comparing the read time information with a system current time; and an inserting unit for in case where the time information is consistent with the current time, reading a corresponding caption data, and inserting an OSD signal of the caption data into the processed video signal depending on the read caption data.

In a further aspect of the present invention, there is provided a caption data displaying method including the steps of: (a) extracting caption data from a video signal in a video decoder to store the extracted caption data and time information for a caption data display in a memory; (b) comparing the stored time information with a system current time to determine whether or not it is a time to display the caption data; and (c) in case where it is the time to display the caption data, reading a corresponding caption data from the memory and inserting the read caption data into the video signal to display the video signal on a screen.

Preferably, in the step (a), it is determined whether or not the time information is inserted into the caption data, and wherein the method further comprises the step of: (d) in case where it is determined that the time information is not inserted, reading the caption data to insert the read caption data into a current video signal and display the video signal on the screen.

Preferably, in the step (c), the inserting of the caption data into the video signal is performed using an OSD signal.

Preferably, in the step (b), the inserted time information is compared with the current time and, in case where it is determined as a comparative result that the time information is consistent with the current time, it is determined that it is the time to display the caption data.

Preferably, in the step (b), after the caption data is received, the received caption data is inserted into the video signal a predetermined few seconds or minutes later to display the video signal on the screen.

Preferably, the method further includes the step of: determining as to whether or not the time information is respectively inserted into the caption data, which is provided in plural, to display the caption data at a corresponding time.

It is to be understood that both the foregoing general description and the following detailed description of the present invention arc exemplary and explanatory and are intended to provide further explanation of the invention as claimed.

### BRIEF DESCRIPTION OF THE DRAWINGS

The accompanying drawings, which arc included to provide a further understanding of the invention and are incorporated in and constitute a part of this application, illustrate embodiment(s) of the invention and together with the description serve to explain the principle of the invention. In the drawings:

FIG. 1 is a view illustrating an example of a conventional caption data transmitted;

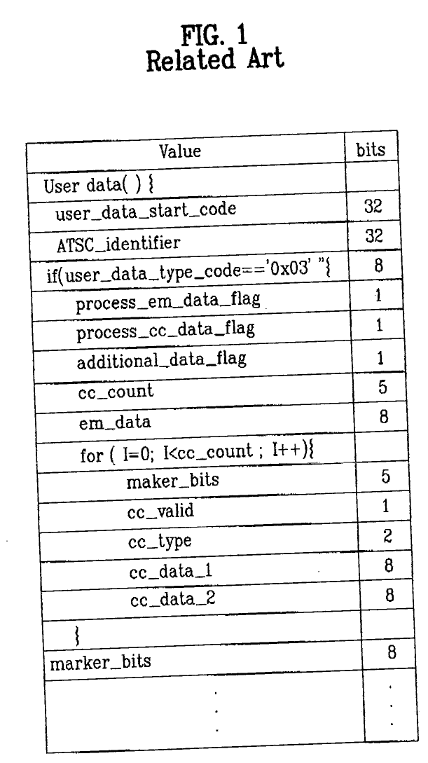

FIG. 2 is a view illustrating a configuration of caption data having inserted time information, at which the caption data is displayed, according to a caption data displaying method of the present invention;

FIG. 3 is a block diagram illustrating a construction of a digital television receiver using a caption data displaying method according to the present invention; and

FIG. 4 is a flowchart illustrating a caption data displaying method according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

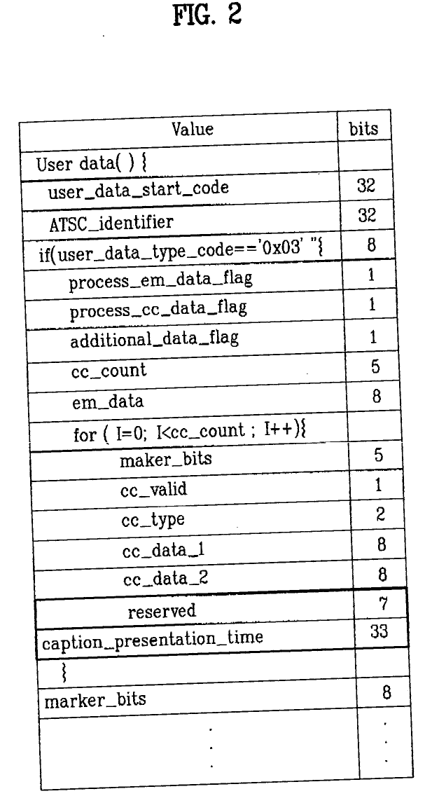

FIG. 2 is a view illustrating a configuration of caption data having inserted time information, at which the caption data is displayed, according to a caption data displaying method of the present invention.

The caption data according to the present invention includes the time information for a caption data display in a Motion Picture Experts Group (MPEG) user data area, and is used for an Advanced Television System Committee (ATSC) broadcasting signal.

Further, the time information is comprised of caption presentation time data and reserved data. The caption presentation time data is 33 bits, and the reserved data is 7 bits.

At this time, the caption presentation time data has the time information for the caption data display, and the reserved data sets a total number of bytes of a user data area of a video picture layer.

A digital television receiver and a caption data displaying method using the above-structured caption data are described with reference to the attached drawings as follows.

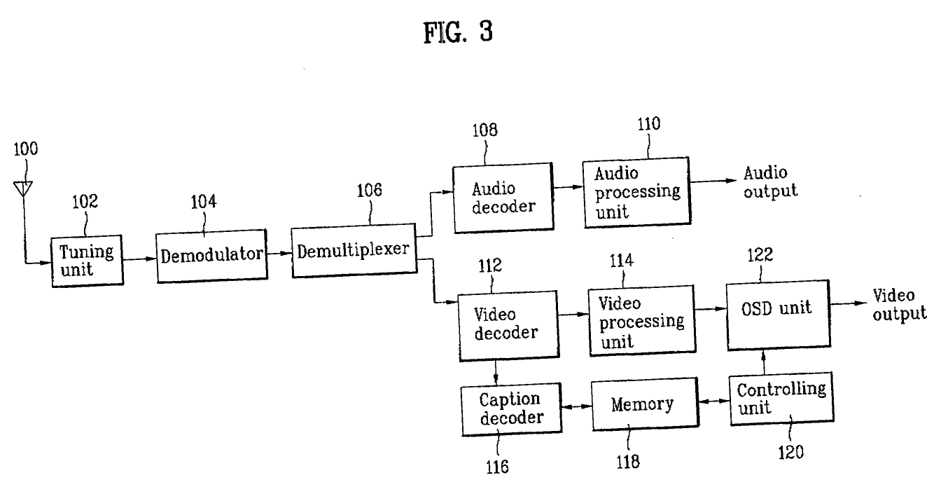

FIG. 3 is a block diagram illustrating a construction of the digital television receiver using the caption data displaying method according to the present invention.

As shown in FIG. 3, the digital television receiver includes a tuning unit 102 for receiving a predetermined channel broadcasting signal through an antenna 100; a demodulator 104 for demodulating the received broadcasting signal; and a demultiplexer 106 for separating an audio signal and a video signal from an output signal of the demodulator 104. Additionally, the digital television receiver includes an audio decoder 108 for decoding the separated audio signal; and a audio processing unit 110 for processing and outputting the decoded audio signal. Further, the digital television receiver includes a video decoder 112 for decoding the separated video signal and concurrently, separating the caption data; and a video processing unit 114 for processing the decoded video signal. Furthermore, the digital television receiver includes a caption decoder 116 for decoding the separated caption data; a memory 118 for storing the decoded caption data; and a controlling unit 120 for determining whether or not the stored caption data has the time information to control to display the caption data in case where it is determined that the stored caption data does not have the time information, and control to display the caption data at a corresponding time in case where it is determined that the stored caption data has the time information. Additionally, the digital television receiver includes an On Screen Display (OSD) unit 122 for generating an On Screen Display (OSD) signal under the control of the controlling unit 120 to synthesize the generated signal to the processed video signal processed.

In the above-constructed digital broadcasting receiver, the tuning unit 102 receives the predetermined channel broadcasting signal through the antenna 100, and then the demodulator 104 demodulates the received signal, and then the demultiplexer 106 separates and outputs the audio signal and the video signal.

Additionally, the audio decoder 108 decodes the outputted audio signal, and the audio processing unit 110 processes and outputs the decoded audio signal so that a user can listen to the audio signal.

Further, the video decoder 112 decodes the outputted video signal and concurrently, separates the caption data, and the video processing unit 114 processes and outputs the decoded video signal.

The caption decoder 116 receives and decodes the separated caption data and then, the memory 118 stores the decoded caption data.

In such a state, the controlling unit 120 determines whether or not the time information, at which the caption data is displayed, is inserted into the stored caption data.

In case where it is determined that the time information is not inserted, the caption data is read, and the OSD unit 122 is controlled depending on the read caption data to insert the OSD signal of the caption data into the video signal processed in the video processing unit 114. If so, the video signal having the inserted OSD signal of the caption data is outputted and displayed on the screen so that the user can view the video signal.

Further, in case where it is determined that the time information is inserted, the controlling unit 120 compares the time information with a current time. Additionally, in case where it is determined that the time information is consistent with the current time, a corresponding caption data is read from the memory 118, and the OSD unit 122 is controlled depending on the read caption data to insert the OSD signal of the caption data into the video signal processed in the video processing unit 114. If so, the video signal having the inserted OSD signal of the caption data is outputted and displayed on the screen so that the user can view the video signal.

The method of displaying the above-constructed caption data according to the present invention is in detail described with reference to the attached drawings as follows.

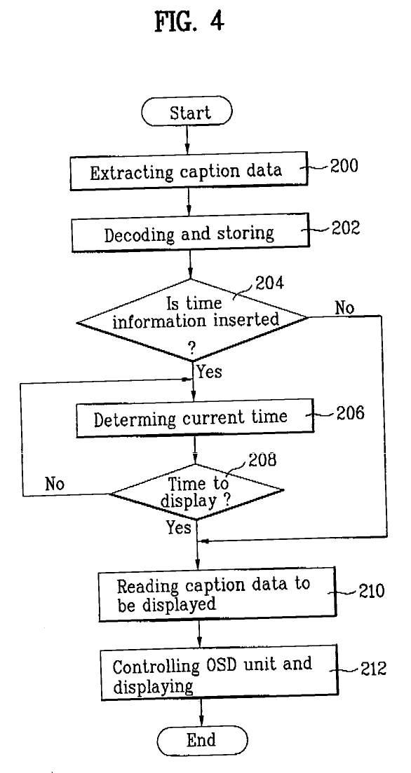

FIG. 4 is a flowchart illustrating the caption data displaying method according to the present invention.

As shown in FIG. 4, in step 200, the video decoder 112 extracts the caption data from the separated video signal, and in step 202, the caption decoder 116 decodes the extracted caption data to store the decoded caption data in the memory 118.

In step 204, the controlling unit 120 determines whether or not the time information is inserted into the stored caption data. Additionally, in case where it is determined that the time information is not inserted, the controlling unit 120 extracts the caption data from the memory 118, and controls the OSD unit 122 depending on the extracted caption data to insert the OSD signal of the caption data into the video signal and display the video signal having the inserted OSD signal on the screen.

Additionally, in case where it is determined as the determination result of the step 204 that the time information is inserted, the controlling unit 120 determines the current time in step 206. In other words, the controlling unit 120, which generally has a function of timer to count the current time, determines the counted current time.

In step 208, the time information inserted into the caption data is compared with the determined current time to determine as to whether or not it is a time to display the caption data. In case where it is determined that it is not the time to display the caption data, the step 206 returns to determine the current time, and the step 208 is repetitively performed to determine as to whether or not it is the time to display the caption data.

In such a state, if the time information of the caption data is consistent with the current time, the controlling unit 120 determines that it is the time to display the caption data in the step 208.

Next, in step 210, the stored caption data is extracted, and in step 212, the OSD unit 122 is controlled depending on the extracted caption data to insert the OSD signal of the caption data into the video signal and display the video signal on the screen.

It will be apparent to those skilled in the art that various modifications and variations can be made in the present invention. Thus, it is intended that the present invention covers the modifications and variations of this invention provided they come within the scope of the appended claims and their equivalents.

For example, in the above-exemplified description, the time at which the caption data is displayed is inserted as the time information, and in case where the inserted time is consistent with the current time, the caption data is displayed.

However, the present invention is not limited to this. In the modifications and variations of the present invention, after the caption data is received, the time information at which the caption data is displayed a few seconds or minutes later is also inserted into the received caption data so that the digital television receiver can display the received caption data a few seconds or minutes later.

Further, in the above-exemplified description, one caption data is received and displayed. However, a plurality of caption data are received and stored in the memory 118, and it is determined as to whether or not the time information is inserted into the stored plurality of caption data, to display the caption data at a corresponding time.

As described above, in the present invention, the time information is inserted into the caption data, and the caption data is displayed on the screen depending on the inserted time information. Information of the desired caption data can be provided to the user of the digital television receiver at a predetermined time required by a manager of the broadcasting station.

1. Caption data having time information for a caption data display in an MPEG (Motion Picture Experts Group) user data area.

2. The caption data of claim 1, being used in an ATSC (Advanced Television System Committee) broadcasting signal.

3. The caption data of claim 1, wherein the time information is comprised of caption presentation time data and reserved data.

4. The caption data of claim 3, wherein the caption presentation time data is 33 bits, and the reserved data is 7 bits.

5. The caption data of claim 1, wherein the caption data has a configuration of FIG. 2.

6. A digital television receiver using caption data, the receiver comprising:
a tuning unit for receiving a predetermined channel broadcasting signal through an antenna;
a demodulator for demodulating the received broadcasting signal;
a demultiplexer for separating an audio signal and a video signal from an output signal of the demodulator;
a video decoder for decoding the separated video signal to separate the caption data from the decoded video signal;
a video processing unit for processing the decoded video signal;
a caption decoder for decoding the separated caption data to read time information for a caption data display; and
a controlling unit for controlling to display the caption data at a corresponding time by using the decoded caption data and the time information.

7. The receiver of claim 6, further comprising: an OSD (On Screen Display) unit for generating an OSD signal of the caption data at a corresponding time under the control of the controlling unit by using the read time information, to synthesize the generated OSD signal with the processed video signal.

8. The receiver of claim 6, further comprising: an audio processing unit for decoding and processing the audio signal outputted from the demultiplexer so that a user can listen to the audio signal.

9. The receiver of claim 6, further comprising: a memory for temporarily storing the decoded caption data and the time information.

10. The receiver of claim 9, further comprising: an OSD (On Screen Display) unit for generating an OSD signal of the caption data at a corresponding time under the control of the controlling unit by using the stored time information, to synthesize the generated OSD signal with the processed video signal.

11. The receiver of claim 6, wherein the video decoder decodes the separated video signal to read the caption data.

12. The receiver of claim 6, wherein the caption decoder decodes the separated caption data to transmit the existence or absence of the time information to the controlling unit.

13. The receiver of claim 12, wherein the controlling unit controls to immediately display a corresponding caption data or display the caption data at a corresponding time, depending on the transmitted existence or absence of the time information.

14. The receiver of claim 6, wherein the controlling unit comprises:
a comparator for comparing the read time information with a system current time; and
an inserting unit for in case where the time information is consistent with the current time, reading a corresponding caption data, and inserting an OSD signal of the caption data into the processed video signal depending on the read caption data.

15. A caption data displaying method comprising the steps of:
(a) extracting caption data from a video signal in a video decoder to store the extracted caption data and time information for a caption data display in a memory;
(b) comparing the stored time information with a system current time to determine whether or not it is a time to display the caption data; and
(c) in case where it is the time to display the caption data, reading a corresponding caption data from the memory and inserting the read caption data into the video signal to display the video signal on a screen.

16. The method of claim 15, wherein in the step (a), it is determined whether or not the time information is inserted into the caption data, and
wherein the method further comprises the step of: (d) in case where it is determined that the time information is not inserted, reading the caption data to insert the read caption data into a current video signal and display the video signal on the screen.

17. The method of claim 15, wherein in the step (c), the inserting of the caption data into the video signal is performed using an OSD signal.

18. The method of claim 15, wherein in the step (b), the inserted time information is compared with the current time and, in case where it is determined as a comparative result that the time information is consistent with the current time, it is determined that it is the time to display the caption data.

19. The method of claim 15, wherein in the step (b), after the caption data is received, the received caption data is inserted into the video signal a predetermined few seconds or minutes later to display the video signal on the screen.

20. The method of claim 15, further comprising the step of: determining as to whether or not the time information is respectively inserted into the caption data, which is provided in plural, to display the caption data at a corresponding time.
